(19) United States
(12) Patent Application Publication
(10) Pub. No.: US 2011/0068555 A1
(43) Pub. Date: Mar. 24, 2011

(54) Quick Release Disk Brake System and Steering Lock-Suspension System

(76) Inventors: Joel Hoag, Brooklyn, NY (US); Li Ho Tsang, Yuanchang Township (TW)

(21) Appl. No.: 12/884,432

(22) Filed: Sep. 17, 2010

Related U.S. Application Data
(60) Provisional application No. 61/244,664, filed on Sep. 22, 2009.

(51) Int. Cl. B62K 21/20; F16D 55/02; B23P 19/00

(52) U.S. Cl. 280/283; 188/71.1; 29/426.1

(57) ABSTRACT

In one aspect, there is provided a vehicle comprising a disk brake rotatably mounted thereto and a wheel that is removably securable to the disk brake, the disk brake and wheel forming a single rotational unit when secured to each other. In another aspect, there is provided a combination suspension system and steering lock for a wheel assembly on a vehicle. The combination is adapted to lock and release steering rotation of a wheel on the wheel assembly and simultaneously provide shock absorption.

### BACKGROUND OF THE INVENTION

1. Field of Invention

The present invention relates to releasable wheel-disk brake combinations and steering lock suspension system combinations for vehicles. This application claims priority to U.S. Provisional Application No. 61/244,664.

2. Description of Related Art

Vehicles, especially those propelled by human exertion, such as bicycles, strollers, stroller-cycles and joggers, often provide means for quick and convenient disassembly. A convertible stroller-cycle, for example, may be operated as a single vehicle whereby a cycle portion propels a stroller portion such that, e.g., an adult cycle rider may transport a child seated in the stroller portion. The stroller portion is ideally adapted to quickly and easily disassemble from the cycle portion such that the cycle portion and stroller portion may be operated independently. Such disassembly would generally involve removal of one or more wheels from the vehicle. Exemplary convertible stroller-cycles are described in U.S. Pat. Pub. No. 2010/0032925 (Ehrenreich, et al.) and U.S. Pat. No. 7,780,184 (Ehrenreich, et al.), which are incorporated herein by reference in their entireties.

Disk brakes are sometimes used on vehicles propelled by human exertion. Typically with such vehicles, e.g., a bicycle, the disk brake is unitary with the wheel hub. A portion of the disk brake is usually surrounded on both sides by a brake caliper with pistons that are adapted to press against the disk when actuated in order to achieve braking. With this configuration, the wheel cannot be disassembled from the vehicle in a direction in line with the axis of rotation of the wheel because the brake caliper obstructs removal of the wheel in that direction. Thus, the wheel must be removed in a direction perpendicular to the axis of rotation of the wheel. Some vehicles, however, such as the stroller portion of the stroller-cycle described above, are configured in such a way as not to allow for disassembly of a wheel in a direction perpendicular to the axis of rotation of the wheel. Accordingly, what is needed is a vehicle that is braked with a disk brake which allows for removal of a wheel in a direction in line with the axis of rotation of the wheel.

Further, a vehicle such as the stroller portion of the stroller-cycle described above may include rear wheels which are adapted for steering when the stroller is assembled with the cycle. These wheels, however, are ideally prevented from steering when the stroller portion is disassembled from the cycle. A steering lock may be used to prevent steering in such situations. Also, a vehicle such as the stroller portion of the stroller-cycle, ideally would include a shock absorption system to increase comfort of a passenger and reduce wear and tear on the vehicle.

However, the combination of both a steering lock and suspension system on such a vehicle has not been implemented, likely because a typical suspension system includes a spring which obstructs the mating surface that would otherwise interlock with a steering lock. Accordingly, what is needed is a combination suspension system and steering lock for a wheel assembly on such a vehicle.

### BRIEF SUMMARY OF THE INVENTION

In accordance with one aspect of the present invention, there is provided a vehicle comprising a disk brake rotatably mounted thereto and a wheel that is removably securable to the disk brake. The disk brake and wheel form a single rotational unit when secured to each other.

In another aspect of the present invention, a method of removing a wheel from a vehicle is provided. The wheel has a central axis of rotation. A disk brake is rotatably mounted to the vehicle. The disk brake and wheel have interlocking mating pieces that when interlocked, unite the disk brake and wheel into a single rotational unit. The method includes separating the wheel from the disk brake in a direction in line with the axis of rotation of the wheel.

In accordance with another aspect of the present invention, there is provided a combination suspension system and steering lock for a wheel assembly on a vehicle. The wheel assembly is secured to a steering post which is adapted to provide steering rotation of a wheel on the wheel assembly. The steering post is inserted through first and second flanges of the vehicle. The combination includes a spring around at least a portion of the steering post between the first and second flanges and a locking post adjacent to the steering post. The locking post is adapted to engage the steering post in a locked position wherein steering rotation of the wheel is prevented. The locking post is further adapted to release the steering post in an unlocked position wherein steering rotation of the wheel is enabled.

### BRIEF DESCRIPTION OF THE DRAWINGS

The invention will be described in conjunction with the following drawing in which like reference numerals designate like elements and wherein:

FIG. 1 shows an exemplary fully assembled vehicle for pushing and riding, e.g., a stroller-cycle;

FIG. 2 shows an exemplary pushing section of the vehicle of FIG. 1.

FIG. 3 shows an isometric view of a wheel-disk brake combination in a released state and a combination suspension system and steering lock.

FIG. 4 shows an isolated isometric view of the disk brake and a portion of the wheel of FIG. 3.

FIG. 5A shows an isometric view of the combination suspension system and steering lock of FIG. 3 in a locked position.

FIG. 5B shows an isometric view of the combination suspension system and steering lock of FIG. 3 in an unlocked position.

FIG. 6A shows a sectional view along section line 6A-6A of FIG. 5A.

FIG. 6B shows a sectional view along section line 6B-6B of FIG. 5B.

### DETAILED DESCRIPTION OF THE INVENTION

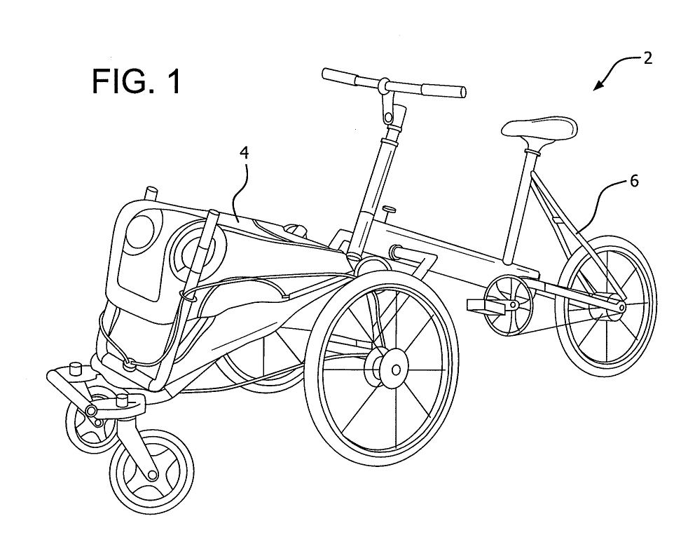

Referring to FIG. 1, there is shown an exemplary vehicle 2 for pushing and riding, e.g., a convertible stroller-cycle. The vehicle 2 has a pushing section 4 comprising a stroller for a passenger and a riding section 6 comprising a cycle for a rider. As explained in U.S. Pat. Pub. No. 2010/0032925 and U.S. Pat. No. 7,780,184, the pushing section 4 and riding section 6 may be operated independently of one another. That is, the pushing section 4 may be used, e.g., as a stroller that can be pushed by a user while walking or running and the riding section 6 may be operated independently as a cycle.

Separate pushing and riding sections 4,6 may be easily and quickly coupled to one another and thus converted into to the vehicle 2 without tools, e.g., in the manner described in U.S. Pat. Pub. No. 2010/0032925 and U.S. Pat. No. 7,780,184, so that a rider on the riding section 6 may transport a passenger on the pushing section 4. The vehicle 2 may also be easily separated without tools, in the manner described in U.S. Pat. Pub. No. 2010/0032925 and U.S. Pat. No. 7,780,184, so that the pushing section 4 and riding section 6 may be used separately. The vehicle 2 described and shown herein is merely illustrative of a vehicle with which aspects of the present invention may be implemented. It is contemplated that various aspects of the present invention may be implemented with any vehicle, especially those propelled by human exertion, including, but not limited to, bicycles, strollers, stroller-cycles and joggers.

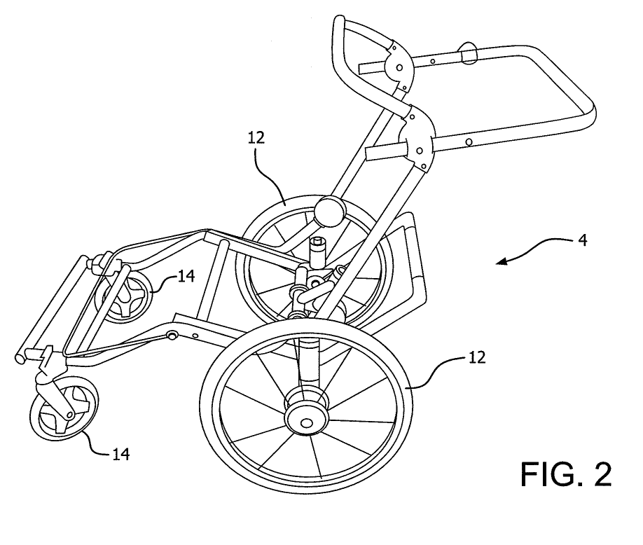

Referring now to FIG. 2, there is shown an exemplary pushing section 4 of the vehicle 2 of FIG. 1. The pushing section 4 includes a pair of wheels 12 towards the rear thereof and a pair of casters 14 towards the front thereof, the casters 14 balancing the pushing section 4 when the pushing section 4 is operated separately from the riding section 6.

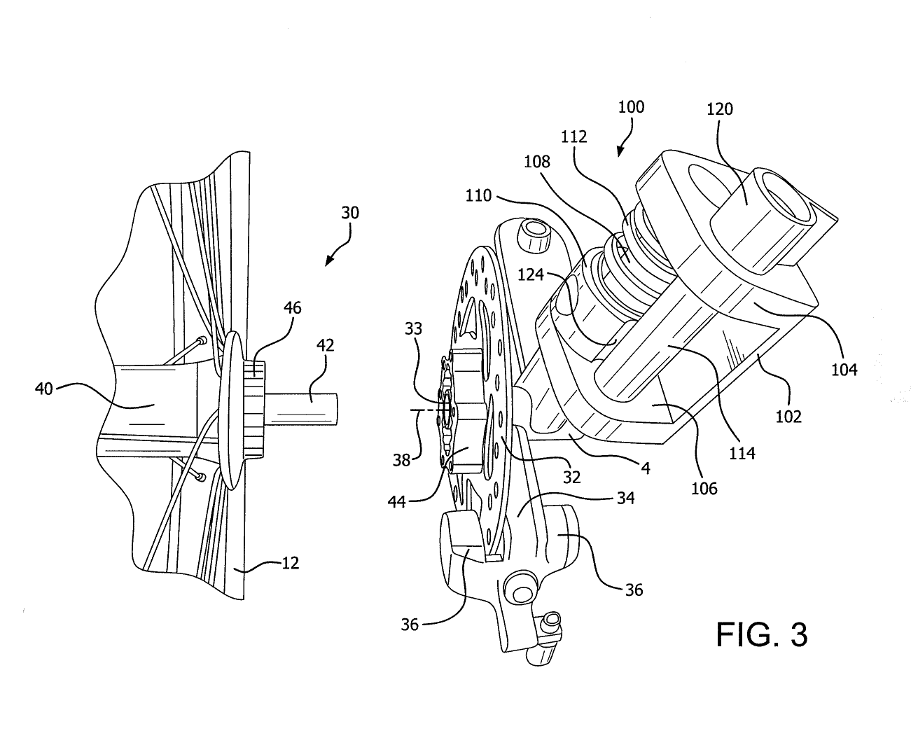

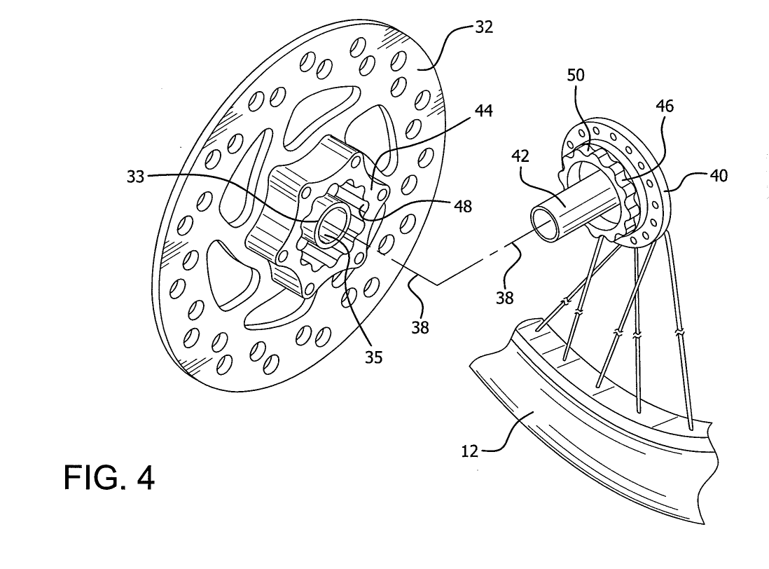

Referring now to FIGS. 3 and 4, in one aspect, the present invention relates to a quick release disk brake system 30. The quick release disk brake system 30 may be incorporated, e.g., onto the pushing section 4 of the vehicle 2 of FIGS. 1 and 2. For example, a disk brake 32 of the quick release disk brake system 30 may be rotatably mounted to the pushing section 4 and adapted for rotary motion about a central axis of rotation 38. Preferably, the disk brake 32 is secured to a tubular wheel mount 33, which is rotatable about the central axis of rotation 38. The wheel mount 33 includes a hole 35 that is aligned with the center of the disk brake 32.

The quick release disk brake system 30 further includes a wheel hub 40 and an axle 42 protruding axially therefrom, the wheel hub 40 being central to and integral with the wheel 12. The axle 42 is adapted to fit tightly inside the hole 35 of the wheel mount 33 and provide load bearing support for the pushing section 4. Once the axle 42 is fully inserted into the wheel mount 33, the axle 42 is preferably retained therein by a quick release mechanism (not shown) such as that described in ¶84 of U.S. Pat. Pub. No. 2010/0032925, thereby securely fastening the wheel 12 to the pushing section 4 until released, e.g., via the quick release mechanism.

The disk brake 32 further comprises a disk mating piece 44 that is located about the center of the disk brake 32, on the side facing the wheel 12. The wheel hub 40 further comprises a hub mating piece 46 that is located on the side of the wheel hub 40 facing the disk brake 32. The disk mating piece 44 preferably has a generally circular interior with a pattern of hills and valleys 48 and the hub mating piece 46 preferably has a generally circular exterior with a pattern of hills and valleys 50. The patterns of hills and valleys 48,50 are adapted to interlock with each other in order to secure the mating pieces 44,46 to each other and form a single rotational unit comprising the wheel 12 and the disk brake 32. Although patters of hills and valleys 48,50 are preferred, various alternative interlocking geometries may be used to achieve the same objective.

When a user wishes to secure the wheel 12 to the wheel mount 33, the user inserts the axle 42 into the hole 35 in the wheel mount 33 and pushes the wheel 12 in a direction in line with the central axis of rotation 38, towards the wheel mount 33. This is done until the hub mating piece 46 is inserted into the disk mating piece 44 such that the respective patterns of hills and valleys 48,50 interlock and thus mate with each other. In this position, the wheel 12 and disk brake 32 form a single rotational unit wherein the wheel 12 is rotationally dependent on the disk brake 32, such that when the disk brake 32 is actuated to slow down and/or stop, so too is the wheel 12. Additionally, in this position, the wheel 12 is secured to the wheel mount 33 such that removal of the wheel 12 therefrom preferably requires actuation of the quick release mechanism. Once the quick release mechanism is actuated, the wheel 12 is no longer secured to the wheel mount 33 and may thus be removed by pulling the wheel 12 away from the wheel mount 33 in a direction in line with the central axis of rotation 38.

As shown in FIG. 3, the pushing section 4 further includes a standard brake caliper 34 having pistons 36 on both sides of the disk brake 32. When a user actuates a braking mechanism (not shown), e.g., a hand brake, such action causes the pistons 36 to press against the disk brake 32, thereby slowing or stopping rotation of the disk brake 32 and wheel 12, thus achieving braking.

In typical disk brake configurations (especially with vehicles such as bicycles), the disk brake is unitary with the wheel hub. With such configurations, the wheel is removable from the vehicle in a direction perpendicular to the central axis of rotation of the wheel. However, the position of the caliper and pistons on both sides of the disk brake renders removal of the wheel in a direction in line with the central axis of rotation impossible, because the caliper obstructs removal of the wheel in this manner. For vehicles which do not allow for removal of a wheel in a direction perpendicular to the axis of rotation, the quick release disk brake system 30 enables a user to remove (and reapply) a wheel, which is braked with a disk brake, in a direction in line with the central axis of rotation. In other words, unlike typical disk brake configurations, the positioning of the brake caliper 34 relative to the quick release disk brake system 30 does not obstruct removal of the wheel 12 in a direction in line with the central axis of rotation 38. This is because the unique configuration of the quick release disk brake system 30 allows the wheel 12 to be removed from the disk brake 32, while the disk brake 32 remains rotatably mounted to the vehicle.

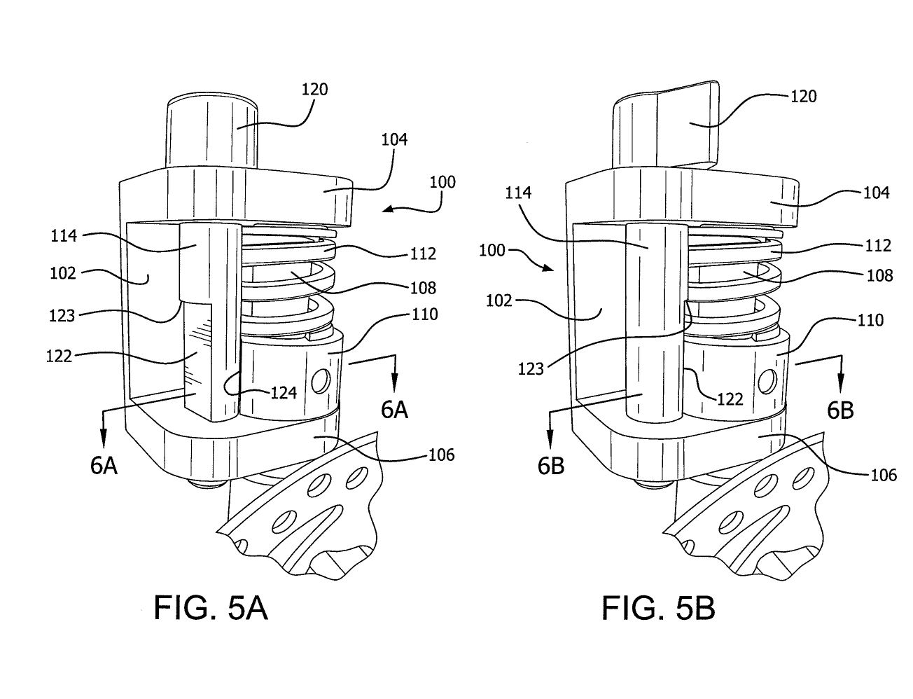

In another aspect of the present invention, there is shown in FIGS. 3 and 5A-5B a combination suspension system and steering lock mechanism 100, which is adapted to prevent accidental steering by locking the wheel 12 from turning left or right, e.g., when the pushing section 4 is used as a stroller, jogger or trailer. The combination 100 provides shock absorption as well.

In one embodiment, the combination 100 includes a bracket 102 mounted to the pushing section 4 above the wheel mount 33, the bracket 102 having a top flange 104 and a bottom flange 106. The wheel mount 33 is secured to a steering post 108 that protrudes upwards through a hole in the bottom flange 106, continuing through the bracket 102 and then into another hole in the top flange 104. Preferably, a steering apparatus (not shown) is connected to the steering post 108, the steering apparatus being adapted to provide steering rotation of the steering post 108 and hence, the wheel 12.

A generally circular collar 110 is rigidly secured to the steering post 108 and is preferably located immediately above the bottom flange 106. A compression spring 112 surrounds a portion of the steering post 108 and sits between the collar 110 and the top flange 104.

The spring 112 provides shock absorption when, for example, the wheel 12 rides over uneven terrain. The steering post 108 is permitted limited movement in an up-down direction. Thus, for example, if the wheel 12 rides over a bump, the steering post 108 moves slightly upwards. This motion compresses the spring 112 against the top flange 104 thus causing the spring 112 to absorb some of the resulting shock.

The combination suspension system and steering lock mechanism 100 further comprises a locking post 114, which is located in the bracket 102, adjacent and parallel to the steering post 108. The locking post 114 preferably protrudes through the top flange 104 and may be adjusted, i.e., rotated, by a knob 120 that is rigidly secured to the top of the locking post 114, above the top flange 104. On one side of the locking post 114, there is a vertical cut-away 122. When the cut-away 122 faces the collar 110, as shown in FIG. 5B, there is clearance between the locking post 114 and the collar 110 such that the locking post 114 does not impede the ability of the steering post 108 (as well as the wheel 12) to rotate (e.g., for steering). One side of the collar 110 also includes a vertical cut-away 124, which is most clearly shown in FIG. 3. The geometry of this cut-away 124 substantially matches the circular geometry of the circumference of the locking post 114 so as to enable the locking post 114 to mate with the cut-away 124, e.g., in the manner discussed, infra.

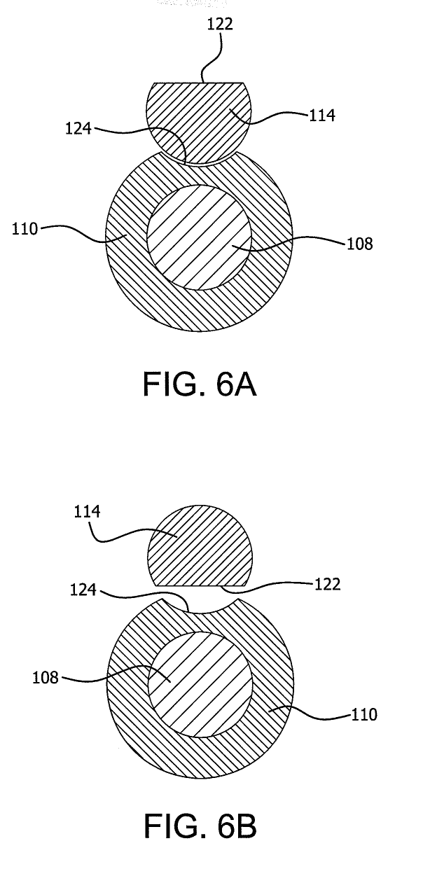

Referring now to FIG. 5A, the combination suspension system and steering lock mechanism 100 is shown in a locked position. The locked position is characterized by engagement of the locking post 114 with the cut-away 124 of the collar 110, which prevents steering rotation of the collar 110 and steering post 108. This locked position is most clearly illustrated in FIG. 6A, which is a cross-sectional view along section line 6A-6A of FIG. 5A.

In order to adjust the combination suspension system and steering lock mechanism 100 from its locked position to an unlocked position, a user would rotate the knob 120, e.g., such that the cut-away 122 of the locking post 114 faces the collar 110, as shown in FIG. 5B. As best shown in FIG. 6B, which is a cross-sectional view along section line 6B-6B of FIG. 5B, the unlocked position is characterized by clearance between the locking post 114 and the collar 110. Accordingly, when the combination suspension system and steering lock mechanism 100 is in its unlocked position, the steering post 108 is free to rotate, e.g., to enable steering of the wheel 12.

As shown in FIG. 5B, when the cut-away 122 of the locking post 114 faces the collar 110, there is clearance between the top of the collar 110 and the ledge 123 of the cut-away 122. This clearance allows the collar 110 to move up and down so that shock absorption may take place, as described supra. Whether the combination suspension system and steering lock mechanism 100 is in its locked or unlocked positions, the steering post 108 is adapted to move up and down while the spring 112 provides shock absorption.

It should be understood that the above description and the accompanying drawing figures are merely exemplary and do not limit the scope of the claimed invention. One skilled in the art would appreciate that various changes and modifications can be made to the above example without departing from the spirit and scope of the claimed invention.

What is claimed is:

1. A vehicle comprising a disk brake rotatably mounted thereto and a wheel that is removably securable to the disk brake, the disk brake and wheel forming a single rotational unit when secured to each other.

2. The vehicle of claim 1, the wheel comprising a first mating piece and the disk brake comprising a second mating piece, wherein the first mating piece is adapted to interlock with the second mating piece to enable the wheel to be removably secured to the disk brake.

3. The vehicle of claim 2, the wheel further comprising a central hub having a vehicle-facing surface comprising the first mating piece, the disk brake having a wheel-facing surface whereon the second mating piece is centrally located.

4. The vehicle of claim 3 wherein the first mating piece and the second mating piece comprise interlocking geometries to facilitate interlocking of the first mating piece with the second mating piece.

5. The vehicle of claim 4 wherein the interlocking geometries comprise hills and valleys.

6. The vehicle of claim 4, wherein the vehicle is selected from the group consisting of bicycles, strollers, stroller-cycles and joggers.

7. A method of removing a wheel having a central axis of rotation from a vehicle, the vehicle comprising a disk brake rotatably mounted thereto, the disk brake and wheel having interlocking mating pieces that when interlocked, unite the disk brake and wheel into a single rotational unit, the method comprising separating the wheel from the disk brake in a direction in line with the axis of rotation of the wheel.

8. The method of claim 7 wherein the vehicle is selected from the group consisting of bicycles, strollers, stroller-cycles and joggers.

9. A combination suspension system and steering lock for a wheel assembly on a vehicle, the wheel assembly being secured to a steering post which is adapted to provide steering rotation of a wheel on the wheel assembly, the steering post being inserted through first and second flanges of the vehicle, the combination comprising a spring around at least a portion of the steering post between the first and second flanges and a locking post adjacent to the steering post, the locking post being adapted to:
a. engage the steering post in a locked position wherein steering rotation of the wheel is prevented; and
b. release the steering post in an unlocked position wherein steering rotation of the wheel is enabled.

10. The combination of claim 9 further comprising a collar rigidly secured around a portion of the steering post between the first and second flanges, the locking post being rotatable and parallel to the steering post, the collar and the locking post having interlocking geometries which interlock when the locking post is rotated to engage the steering post in the locked position, the locking post being adapted not to contact the collar, steering post or spring when the locking post is rotated such that the steering post is in the unlocked position.

11. A combination suspension system and steering lock for a wheel assembly on a vehicle, the wheel assembly being secured to a steering post which is adapted to provide steering rotation of a wheel on the wheel assembly, the steering post being inserted through first and second flanges of the vehicle, the combination comprising a collar rigidly secured around a portion of the steering post between the first and second flanges, a spring around at least a portion of the steering post between the collar and one of the flanges, and a rotatable locking post adjacent and parallel to the steering post, the locking post having a cut-away portion which prevents the locking post from contacting the collar, steering post and spring when the cut-away portion faces the steering post, the collar having a cut-away portion that is engaged by the locking post when the locking post is rotated into a locked position which prevents steering rotation of the wheel.
